(19) United States
(12) Patent Application Publication
(10) Pub. No.: US 2002/0079993 A1
(43) Pub. Date: Jun. 27, 2002

(54) Automatic anti-arcing safety plug receptacle for grounded electrical appliances and utilization equipment

(76) Inventor: Craig Blair Toepfer, Dearborn, MI (US)

Correspondence Address: JOHN M. NABER, 313 SOUTH WASHINGTON SQUARE, LANSING, MI, 48933, US

(21) Appl. No.: 09/746,870

(22) Filed: Dec. 21, 2000

(51) Int. Cl. H01H 73/00

(52) U.S. Cl. 335/18

(57) ABSTRACT

This invention is for an electric plug receptacle that has several safety benefits. The ground terminal on the receptacle is fitted with an actuator and return mechanism to close a sealed set of contacts rated for making and breaking under load when connected to a plug. The contacts are sealed in an enclosed chamber to mitigate or eliminate arcing that can occur when a user fails to turn off an appliance prior to connecting or disconnecting. In the preferred embodiment, when a plug is connected to the receptacle, a first recess within the receptacle allows a seal to form over a specialized annular ring on the plug body to weather-proof electrical contact points. The plug receptacle can also have a cover door hingedly mounted to the receptacle so that moisture is reduced or prevented in wet locations when not in use. A ground fault circuit also provides a measure of safety, especially in damp or wet conditions. The receptacle a 20 MIU current trip and a 5 MIU allowable current leakage. The plug receptacle can also have a second recess sized and aligned to accept a plug body, whereby the possibility of bending, breaking or contacting the plug hot line blade, plug neutral line, and plug ground pin is mitigated or eliminated.

### BACKGROUND OF THE INVENTION

1. Field of the Invention

The present invention relates generally to an electrical plug receptacle configuration and specifically to an improved plug receptacle that utilizes an automatic anti-arcing safety feature.

2. Discussion of the Prior Art

Standard three-pronged grounded electrical receptacles and plug configurations that are in broad use throughout North America were originally developed for use with indoor lighting fixtures. Many and varied uses for this standard configuration have now developed. The expanding use of outdoor appliances has even placed these receptacles and plugs in damp and wet conditions. Proper use requires certain procedures such as turning an appliance off before connecting and disconnecting. Also, care must be exercised to avoid direct contact with “live” parts of the plug (phase contact).

Unfortunately, the standard configuration has several problems. The flat interface plane provides no mechanical protection against bent or broken contacts. Protection is lost if the plug's grounding terminal is damaged or intentionally removed for convenience by the user. Damp or wet conditions also pose a risk of electrical shock hazard.

Another problem arises when a user fails to turn off an appliance prior to connecting or disconnecting from an electrical receptacle. In this situation, an electrical arc at the contact interface may result. The resulting electrical arc could ignite volatile vapors in closed spaces or damage the phase contacts since phase contacts are not designed for breaking power under load conditions.

There exists in the prior art some ways to reduce the hazards from standard grounded electrical receptacles and plug configurations but none address all the problems addressed above. For example, U.S. Pat. No. 3,755,635 to McGill discloses an isolated electrical outlet assembly with a safety control circuit to prevent accidental shock. The receptacle is energized by an actuator pin on the electrical plug upon full insertion into the receptacle. Unfortunately, the actuator pin replaces the ground plug and is not connected to an equipment grounding circuit. Instead, the pin when fully inserted in the electrical terminals simultaneously energizes the circuit. While useful, this invention does not completely address the problems identified above and does not prevent arcing.

U.S. Pat. No. 3,846,598 to Mucsi discloses a safety electrical grounding outlet. The patent proposes a switch system for closing or opening each plug and receptacle circuit in response to insertion or removal of the ground prong of the plug. While generally related to the potential for electrical shock hazards, this invention does not address electrical shock resulting from accidental phase contact or potential hazards related to arcing and liquid ingress.

U.S. Pat. No. 5,095,182 to Thompson is a shockproof safety outlet. The system has a switch system for opening and closing each circuit by inserting the phase contacts of the plug and actuating the switch mounted on the back of the proposed outlet.

U.S. Pat. No. 5,186,639 to Comerci et al., discloses an electrical connector with plug detection switch. The system proposes a resilient actuator to close the circuit and energize the receptacle upon insertion of the male phase contact located on a plug.

U.S. Pat. No. 5,256,076 to Hamlin discloses a safety electrical receptacle. The system proposes an actuator to close the circuit by mounting switches to the back of the receptacle faceplate and utilizing a specially designed plug. Further, the system discloses a switch to close the circuit upon insertion of a grounding prong.

While the prior art discloses numerous ways to adapt electrical plugs and receptacles to reduce or prevent accidental shock, it does not address several of the other problems associated with these devices. Thus, a desire and a need exists to develop an electrical receptacle and plug that goes beyond reducing the risk of accidental shock by an unplugged receptacle. This new device must also address safety concerns associated with bent or broken contacts, removal or damage to the plug's grounding terminal, damp or wet conditions, arcing that occurs when a user fails to turn off an appliance prior to connecting or disconnecting it from an electrical receptacle.

### SUMMARY OF THE INVENTION

The primary goal of the present invention is to provide a safe electrical receptacle and plug that overcomes the shortcomings of the prior art without adding user procedures or special precautions. Accordingly, an object of the present invention is to provide a new method and system to automatically prevent electrical arcing.

A further object of the present invention is to provide a new method and system to prevent accidental phase contact.

Yet another object of the present invention is to provide a new method and system to prevent bent or damaged phase contacts.

A further object of the present invention is to provide a new method and system to prevent liquid ingress into the receptacle for uses in damp or wet conditions.

Other objects of the present invention will become more apparent to persons having ordinary skill in the art to which the present invention pertains from the following description taken in conjunction with the accompanying figures.

### BRIEF DESCRIPTION OF THE FIGURES

The foregoing objects, advantages, and features, as well as other objects and advantages, will become apparent with reference to the description and figures below, in which like numerals represent like elements and in which:

FIG. 1 illustrates a side view of the preferred embodiment of the present invention receptacle and plug unattached and not energized.

FIG. 2 illustrates a side view of the preferred embodiment of the present invention receptacle and plug partially engaged and at the point where energized.

FIG. 3 illustrates a side view of the preferred embodiment of the present invention receptacle and plug fully engaged and energized.

### DETAILED DESCRIPTION OF THE PREFERRED EMBODIMENT

The present invention relates generally to an electrical receptacle and plug configuration and specifically to a new receptacle and plug that utilizes an automatic anti-arcing safety feature.

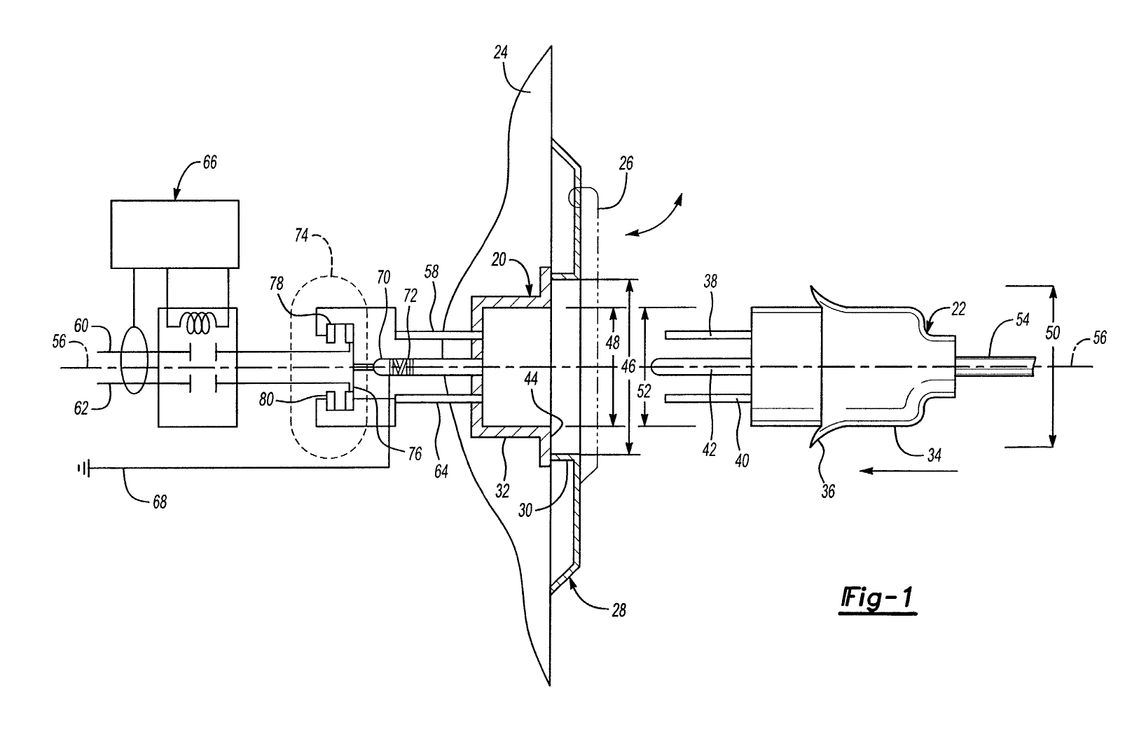

FIG. 1 illustrates one possible configuration of the invention and is the preferred embodiment. A receptacle 20 supplies electricity to an electrical device (appliance) through a plug 22. The receptacle 20 is attached to a surface or a wall 24 and has a cover door 26 hingedly mounted to a cover plate 28 to reduce or prevent moisture in wet locations when not in use. The cover plate 28 has a first recess 30 and second recess 32 to reduce or eliminate the possibility of direct contact with live parts. The second recess 32 has a sealing surface 44. The first recess 30 has a first recess diameter 46 and the second recess 32 has a second recess diameter 48 to reduce or eliminate the possibility of accidental direct contact with the electrified parts of the receptacle 20.

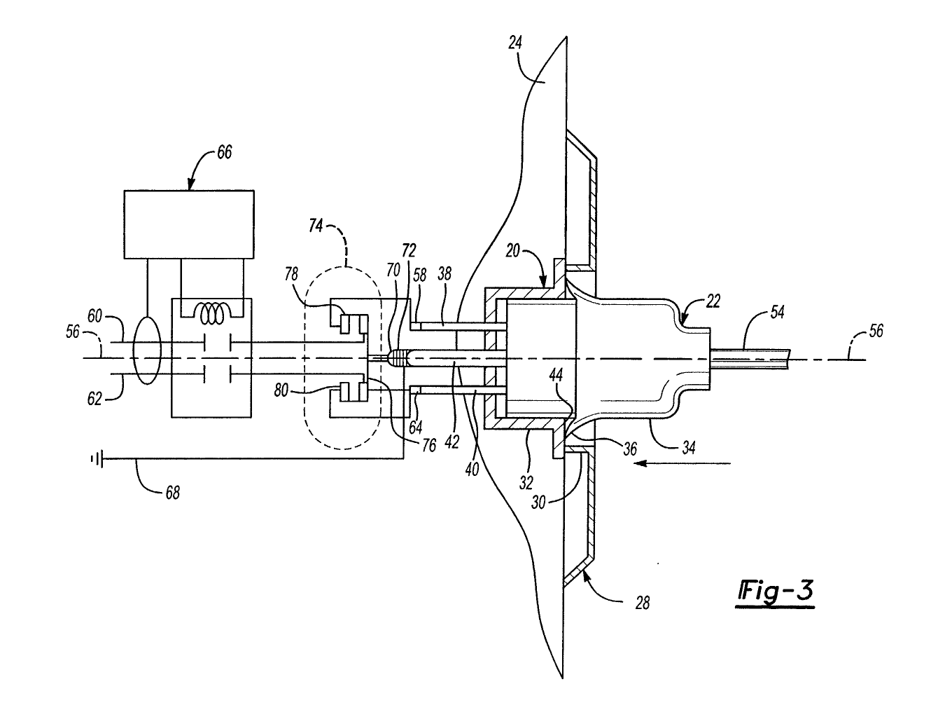

Plug 22 has a plug body 34 and includes an annular ring 36 to match the receptacle's sealing surface 44 used in conjunction with a mating feature on the receptacle 20 described below to eliminate liquid and solid ingress during operation. An annular ring diameter 50 is designed to match the first recess diameter 46, whereby a weatherproof seal is formed when the plug 22 is fully engaged to the receptacle 20 (as illustrated in FIG. 3). The plug 22 has a hot line blade 38, a neutral line blade 40, and a ground pin 42. The plug 22 also has a plug body diameter 52 that is just slightly smaller than the receptacle 20's second recess diameter 48 to allow easy alignment and engagement of the plug 22 to the receptacle 20. This feature avoids or mitigates the possibility of bending or braking the plug 22 contacts (ground pin 42, neutral line blade 40, and hot line blade 38) especially if a disconnection if a plug cord 54 is subjected to pull forces that are not aligned with a plug/receptacle axis 56.

The receptacle 20 has a hot line 60 and a hot line blade slot 58 that corresponds in size and alignment with the plug's hot line blade 38 to receive the hot line blade 38 when the plug 22 is fully engaged with the receptacle 20 as shown in FIG. 3. The receptacle 20 also has a neutral line 62 and neutral line blade slot 64 that correspond in size and alignment with the plug's neutral line blade 40 to receive the neutral line blade 40 when the plug 22 is fully engaged with the receptacle 20 as shown in FIG. 3.

As an added safety feature, the preferred embodiment receptacle 20 also has a ground fault circuit 66 connected to the hot line 60 and neutral line 62 that is well known in the prior art. The ground fault circuit 66 interrupts electricity to the receptacle 20 in the event of short in the circuit, whereby the risk of accidental electric shock is eliminated, especially in damp or wet conditions.

At the heart of the present invention is a system to reduce or eliminate arcing when a user fails to turn off an appliance prior to connecting or disconnecting the plug 22 from the receptacle 20 and a system to energize the receptacle 26 only when there is no possible direct contact to the plug 22 contacts.

The receptacle 20 has a ground line 68 and a ground terminal 70 sized and aligned to receive the ground pin 42. The ground terminal 70 is also fitted with an actuator and return mechanism 72 to close a set of contacts 76 that is rated for making and breaking under load and enclosed within a sealed chamber 74.

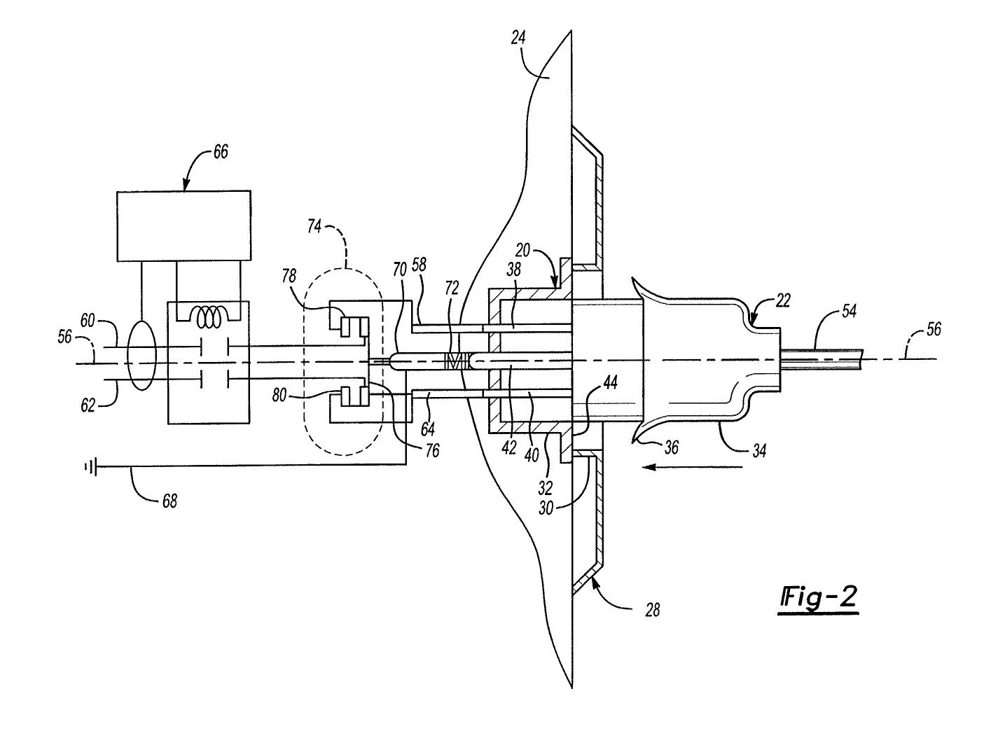

When the plug 22 is inserted in the receptacle 20, as shown in FIG. 2, the ground pin 42 causes the actuator and return mechanism 72 to close the sealed set of contacts 76 to complete a circuit and energize a set of hot line contacts 78 and a set of neutral contacts 80 in the receptacle 20 at a point where direct user contact with the live plug 22 contacts (ground pin 42, neutral line blade 40, and hot line blade 38) is not possible. The sealed chamber 74 prevents the escape of any arcing that my occur while engaging or dis-engaging the plug 22 from the receptacle 20.

Thus, the circuit could be energized at any point after the plug body 34 begins to align and enter the receptacle 20's second recess 32, as shown in FIG. 2. This system eliminates user procedures and due care requirements by automatically de-energizing the receptacle 20 until just prior to complete plug 22 insertion as shown in FIG. 3.

The actuator and return mechanism 72 could be considered as a means to insure a reliable ground line 68 since the receptacle 20 cannot energize without the ground pin 42 firmly in place.

The features of the preferred embodiment allow the present invention to be applied to use new personnel protection devices (20 MIU current leakage trip level limit, and 5 MIU current leakage trip level). An MIU is a measuring indicating unit and is related to human body frequency compensated milliamps and accepts all three classes of appliances (Class 0—two prong, no ground; Class 1—three prong, grounded; and Class 2—double insulated). The 20 MIU is useful over a 5 MIU in applications having multiple devices where leakage among the devices is cumulative or for large appliances).

The preferred embodiment is thus capable of providing protection to larger utilization equipment (i.e., equipment that uses higher power and higher voltage) and electrical products that operate in severe environmental conditions or unique operating conditions such as high mechanical forces (vibration, shock, etc.).

I claim:

1. A safety electrical plug receptacle comprising:
A hot line and a neutral line;
a cover plate comprising a neutral blade-slot and a hot line blade-slot opening to the front, the slot openings aligned and sized for receiving a connecting plug with a neutral line and neutral line blade and a hot line and hot line blade, respectively;
the cover plate further comprising a ground pin opening to the front, the ground pin opening aligned and sized for receiving a connecting plug ground pin;
a normally opened switch assembly of the push-button type electrically connected into a hot line and neutral line and having an actuating mechanism for alignment behind a ground pin opening of the plug receptacle so that when a connecting plug is connected into the plug receptacle, the plug ground pin entering the ground pin opening will depress the actuating mechanism and close the switch assembly thereby energizing the plug receptacle to supply current into the plug, whereby the risk of accidental shock of an unconnected receptacle is reduced or eliminated and the receptacle cannot be energized when the plug ground pin is bent, broken, or unconnected; and
the actuating mechanism housed in a sealed chamber, whereby arcing that can occur when a user fails to turn off an appliance prior to connecting or disconnecting from an electrical receptacle is contained or eliminated.

2. The receptacle plug of claim 1 further comprising a cover door hingedly mounted to the cover plate, whereby moisture is reduced or prevented in wet locations when not in use.

3. The receptacle plug of claim 1 further comprising a ground fault circuit electrically connected to the hot line and neutral line, whereby electricity to the receptacle is interrupted in the event of a short in the circuit especially in damp or wet conditions.

4. The receptacle plug of claim 1 wherein the actuation mechanism allows a 20 MIU current trip level.

5. The receptacle plug of claim 1 wherein the actuation mechanism allows 5 MIU allowable current leakage.

6. The receptacle plug of claim 1 wherein the cover plate has a first recess comprising a sealing surface to an annular plug sealing ring.

7. The receptacle plug of claim 1 further comprising a second recess sized and aligned to accept a plug body, whereby the possibility of bending, breaking or contacting the plug hot line blade, plug neutral line, and plug ground pin is mitigated or eliminated.
